(19) United States
(12) Patent Application Publication
(10) Pub. No.: US 2016/0132681 A1
(43) Pub. Date: May 12, 2016

(54) METHOD FOR PERFORMING A SECURE BOOT OF A COMPUTING SYSTEM AND COMPUTING SYSTEM

(71) Applicant: NEC EUROPE LTD., Heidelberg (DE)

(72) Inventors: Ghassan Karame, Heidelberg (DE); Wenting Li, Heidelberg (DE)

(73) Assignee: NEC EUROPE LTD., Heidelberg (DE)

(21) Appl. No.: 14/890,912

(22) PCT Filed: Jun. 14, 2013
(86) PCT No.: PCT/EP2013/062420

§ 371 Date: Nov. 13, 2015

(51) Int. Cl. G06F 21/57

(52) U.S. Cl. CPC G06F 21/575; G06F 2221/034

(57) ABSTRACT

A method for performing a secure boot of a mobile device computing system that includes a tamper-resistant hardware that provides secure storage of at least a cryptographic private key includes performing a measurement on each system and/or application specific file before said file is being loaded or launched by a kernel module or an application loader of the computing system, directing the measurement results to the tamper-resistant hardware, maintaining an extend-only global counter at the tamper-resistant hardware, increasing the extend-only global counter upon receiving a measurement result, executing a signing process in which the tamper-resistant hardware signs the extend-only global counter together with the measurement result using the cryptographic private key, and keeping a measurement list at the computing system that includes signatures generated by the tamper-resistant hardware.

### CROSS REFERENCE TO RELATED APPLICATIONS

This application is a U.S. National Stage Application under 35 U.S.C. §371 of International Application No. PCT/EP2013/062420 filed on Jun. 14, 2013. The International Application was published in English on Dec. 18, 2014 as WO 2014/198340 A1 under PCT Article 21(2).

### FIELD

The present invention relates to methods for performing a secure boot of a computing system, in particular of a mobile device, wherein the computing system comprises a tamper-resistant hardware component that provides secure storage of at least a cryptographic private key.

Furthermore, the present invention relates to methods for performing remote attestation of a computing system, in particular of a mobile device, wherein the computing system comprises a tamper-resistant hardware component that provides secure storage of at least a cryptographic private key.

Still further, the present invention relates to computing systems, in particular mobile device computing systems, with secure boot functionality that include a tamper-resistant hardware component that provides secure storage of at least a cryptographic private key.

### BACKGROUND

Remote attestation of untrusted devices is gaining increasing popularity nowadays. The literature includes various proposals to establish a static root of trust and/or a dynamic root of trust in various computing environments. This serves either to (1) attest that an untrusted environment can provide some security guarantees and/or to (ii) create a trusted sub-environment within an untrusted computing environment. However, until now, it is not clear how to extend the application/operation of trusted computing to mobile computing environments.

In this respect, there are two proposed directions in the literature. The first nave solution relies on embedding TPM (Trusted Platform Modules) chips within mobile devices and establishing a root of trust within the mobile device itself (see for instance B. Parno, J. M. McCune, A. Perrig: “Bootstrapping Trust in Commodity Computers”, IEEE S&P 2010, or Bernhard Kauer “OSLO: Improving the security of Trusted Computing”, 16th USENIX Security Symposium, Pp. 229-237 of the Proceedings). However, while there are several architectures for standard PC platforms that can support the establishment of a root of trust, this technology is rather immature for mobile devices. Today's mobile computing environments typically are not designed to cope with TPMs.

Other existing proposals suggest embedding secret keys within the mobile phone smart card as a mean to authenticate the mobile device to external entities and/or to bootstrap a trusted computing base in the mobile device itself (see for instance G. Kalman, J. Noll: “SIM as secure key storage in communication networks”, International Conference on Wireless and Mobile Communications (ICWMC), 2007; J. Noll, J. C. Lopez Calvet, K. Myksvoll: “Admittance services through mobile phone short messages”, International Multi-Conference on Computing in the Global Information Technology, pp. 77-82, IEEE Computer Society, Washington, D.C., USA, 2006; or T. Mantoro, A. Milisic: “Smart card authentication for Internet applications using NFC enabled phone”, International Conference on Information and Communication Technology for the Muslim World (ICT4M), 2010). While this is clearly a step in the correct direction, it is believed that there are some inherent problems with this approach. More specifically, current SIM cards cannot fully mimic the functionality of existing TPMs. They do not support restricted operations on Platform Configuration Registers (PCRs) and can be cloned. This suggests that such solutions lack foresight in their design since SIM cards are unlikely to provide alone for a solution to bootstrap trust in a device.

### SUMMARY

According to an embodiment, a method for performing a secure boot of a mobile device computing system that includes a tamper-resistant hardware that provides secure storage of at least a cryptographic private key is provided. The method includes performing a measurement on each system and/or application specific file before said file is being loaded or launched by a kernel module or an application loader of the computing system; directing the measurement results to the tamper-resistant hardware; maintaining an extend-only global counter at the tamper-resistant hardware; increasing the extend-only global counter upon receiving a measurement result; executing a signing process in which the tamper-resistant hardware signs the extend-only global counter together with the measurement result using the cryptographic private key; and keeping a measurement list at the computing system that includes signatures generated by the tamper-resistant hardware.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic view showing the basic components of a computing system with secure and authenticated boot functionality in accordance with an embodiment of the present invention, and

FIG. 2 is a schematic view showing the architecture of an Android operating system including an integrated integrity measurement scheme in accordance with an embodiment of the present invention.

### DETAILED DESCRIPTION

An embodiment of the present invention improves and further develops methods and computing systems in such a way that gaps in different prior art solutions are bridged by providing a solution that enables secure and authenticated boot, in particular within mobile devices, and that further enables remote attestation, without relying on TPM chips.

In an embodiment, a method for performing a secure boot of a computing system includes:

performing a measurement on each system and/or application specific file before said file is being loaded or launched by a kernel module or an application loader of the computing system, and directing the measurement results to said tamper-resistant hardware component,

maintaining an extend-only global counter at said tamper-resistant hardware component and increasing said counter upon receiving a measurement result,

executing a signing process in which said tamper-resistant hardware signs said counter together with said measurement result using said private key, and

keeping a measurement list at the computing system that includes the signatures generated by said tamper-resistant hardware component.

In an embodiment, a computing system is provided that includes:

a software based integrity measurement component being configured to perform a measurement on each system specific file and/or an application loader being configured to perform a measurement on each application specific file before said files are being loaded or launched, and to direct the measurement results to said tamper-resistant hardware component,

wherein said tamper-resistant hardware component is configured to maintain an extend-only global counter, to increase said counter upon receiving a measurement result, and

to execute a signing process in which said counter together with said measurement result is signed using said private key, and

means for keeping a measurement list that includes the signatures generated by said tamper-resistant hardware component.

According to an embodiment of the present invention, it has been recognized that a solution that enables secure and authenticated boot, in particular within mobile devices, and that further enables remote attestation, without relying on TPM chips can be accomplished by performing measurements on each file to be loaded/launched and by basically emulating the “extend-only” functionality of TPMs using counters and lightweight cryptography offered by existing smart cards. By combining these features, an integrity measurement architecture can be constructed that provides secure and authenticated boot of computing devices in spite of an adversary that basically could corrupt, delete and/or modify the measurement logs stored on the computing system. However, according to an embodiment of the present invention the adversary cannot delete or modify any measurement entries, as each measurement was signed by the tamper-resistant hardware component.

By performing the measurements, an integrity check is kept that leverages lightweight cryptography and the counter inside the smart card. The integrity check prevents any tampering with the results and is therefore important for the security of the scheme. It is noted that according to the present invention the adversary can neither trick the tamper-resistant hardware component to get a replaceable signature of a genuine measurement to replace the existing one, as the increase-only global counter is maintained by the tamper-resistant hardware component and included in the signatures.

An embodiment of the present invention proves to be particularly useful for deployment in mobile devices like smartphones, which typically are not equipped with a TPM chip. In other words, the present invention enables the sharing of similar TPM functionality across devices that do not have support for TPM. Moreover, the present invention enables the construction of a trusted execution environment within an untrusted device.

According to a preferred embodiment the tamper-resistant hardware component may be a smart card, in particular a SIM (Subscriber Identity Module) card, as they are currently included in every mobile device. These cards typically offer secure storage of cryptographic keys, secure hosting of applets, secure cryptographic algorithms, etc., such that no additional tamper-resistant hardware component is required for executing the present invention.

According to one embodiment the tamper-resistant hardware component may be configured to maintain a local register of the summary of the signatures the component has calculated. The register may be a register of the extend-only type, i.e. it is only extendable, which means that it is impossible to delete any entries once they have been stored in the register. Specifically, during boot and operation of the computing system the register may be extended each time the tamper-resistant hardware component executes a signing process, i.e. whenever it signs a measurement result. Such extended summary within the tamper-resistant hardware component provides an additional insurance layer, since any manipulation of the measurement list will be detected.

In the context of the present invention the term ‘file’ as employed herein is to be understood in a rather broad sense. In particular, the files on which the measurements are performed may include classes, libraries, executables, kernel models, application files and/or configuration files. As will be appreciated by those skilled in the art the above list is a non-exhaustive list, and further types of files may be envisioned on which the measurements may be extended, generally depending on the desired degree of trust and authenticity.

According to a preferred embodiment the measurements are performed by calculating the hash of the content of the file being measured.

Advantageously, a service is provided on the computing system that interfaces between the kernel of the computing system and the tamper-resistant hardware component. This service may be configured to receive the measurement results and to direct the measurement results together with a respective signing request to the tamper-resistant hardware component. Furthermore, the service may be configured to receive the signatures generated by the tamper-resistant hardware component and to keep the measurement list. According to one embodiment the service may be implemented as a native daemon. Preferably, the service runs in kernel space, and is therefore isolated from user-space applications, which strengthens its security against attacks.

Embodiments of the present invention may distinguish between system specific files on the one hand and application specific fonts on the other hand, which are generally handled separately. For instance, with respect to the measurement process, it may be provided that the measurements on system specific files are performed by a software based integrity measurement component implemented on the computing system. This component may include an IMA (Integrity Measurement Architecture) kernel module, for instance an IMA module of the type developed by IBM (see for reference http://researcher.watson.ibm.com/researcher/view_project.php?id=2851). On the other hand, the measurements on application specific files may directly be performed by an application loader implemented on the computing system. In a similar way, also the measurement lists may be generated and stored separately for measurements performed on system specific files and for measurements performed on application specific files.

According to an embodiment an encryption of the measurement results related to application specific files is provided before the measurement results are directed to the interface service. The encryption may be performed by using a key derived from a master key of the tamper-resistant hardware component.

According to a preferred embodiment it may be provided that basic system files of the computing systems that are loaded before the tamper-resistant hardware component becomes active are launched according to a preset white list to ensure the integrity.

According to an embodiment a method includes the steps of:

a verifier sending an attestation request including a challenge to the computing system, wherein the challenge is being directed to said tamper-resistant hardware component,

upon receiving said challenge, said tamper-resistant hardware component preparing an extended summary of the measurements from its register,

sending back to the verifier said extended summary together with said measurement list, such that the integrity of each loaded file can be verified by checking the signed measurement results.

Insofar, according to an embodiment of the present invention it has been recognized that based on the above authenticated boot of a computing system a secure attestation protocol can be implemented, which is resilient to various of adversarial strategies. According to the invention the tamper-resistant hardware component, upon receiving a challenge/nonce from a verifier, prepares an extended summary of the measurements from its register. This means that the tamper-resistant hardware component signs the value of the registers along with the nonce received from the verifier. The verifier is sent back the value of the registers as well as the signature together with the measurement list. The verifier can thus check the measurement of each loaded file to see if it has been tampered or not. The integrity of the measurement will be ensured by the signature of the tamper-resistant hardware component; and the integrity of the measurement list and its freshness will be ensured by the signed extended summary.

While the present invention provides a flexible architecture that can enforce different degrees of protection against a wide range of attacker strengths, it does not prevent all software attacks, which is a characteristic that have all attestation-based techniques in common Opportunistic exploits could still be performed due to flaws in software, zero-day vulnerabilities, etc. However, these exploits can only go undetected when they occur in between two consecutive reboots of the computing system.

According to a preferred embodiment the challenge includes an (unpredictable) random number.

Since all the measurements will be cleared on a reboot of the computing system, I an adversary may want to reboot the computing system and give a clean measurement result upon an attestation request. However, according to an embodiment, on the side of the verifier, a response time window is set in order to detect such case, as the reboot time will bring a significant difference in the delay of the response.

There are several ways how to design and further develop the teaching of the present invention in an advantageous way. To this end it is to be referred to the patent claims subordinate to patent claims 1, 14, and 20 on the one hand and to the following explanation of preferred embodiments of the invention by way of example, illustrated by the drawing on the other hand. In connection with the explanation of the preferred embodiments of the invention by the aid of the drawing, generally preferred embodiments and further developments of the teaching will be explained. In the drawing

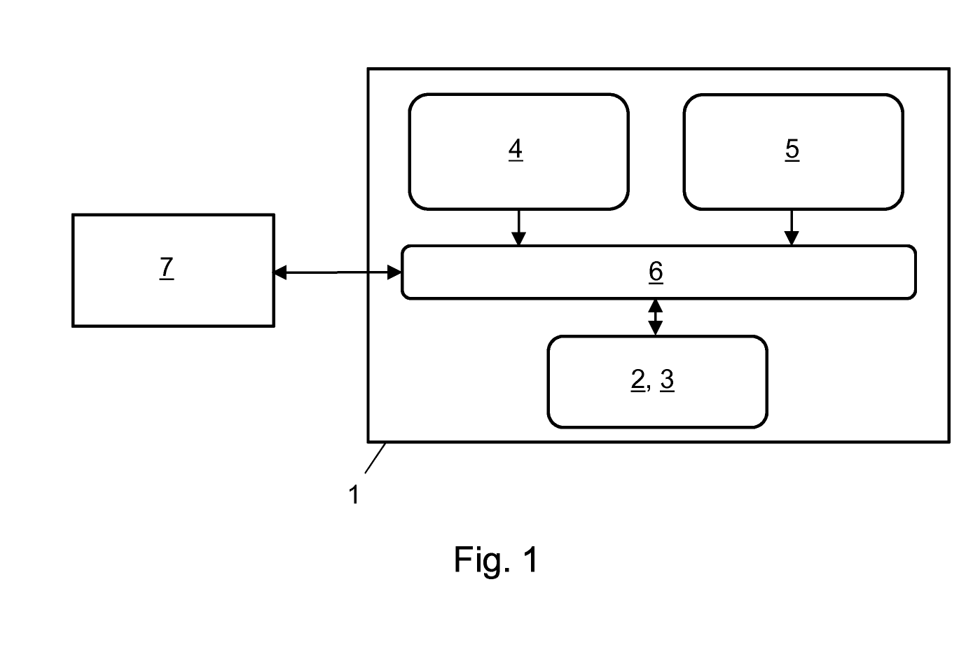

FIG. 1 is a schematic view showing the basic components of a computing system with secure and authenticated boot functionality in accordance with an embodiment of the present invention, and

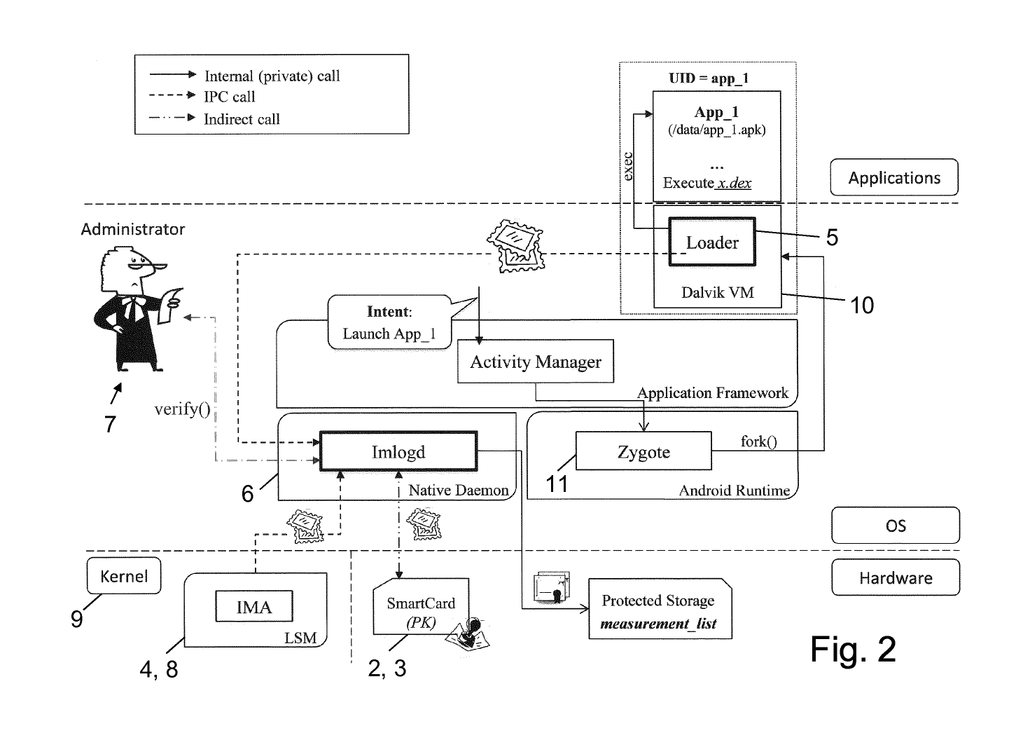

FIG. 2 is a schematic view showing the architecture of an Android operating system including an integrated integrity measurement scheme in accordance with an embodiment of the present invention.

FIG. 1 schematically illustrates a simple embodiment of the present invention. More specifically, FIG. 1 depicts a computing system 1 that provides secure and authenticated boot functionality without relying on TPM chips, but solely relying on a tamper-resistant hardware component 2, which in the illustrated embodiment is a smart card 3.

The computing system 1 includes a software-based integrity measurement component 4, which is configured to perform a measurement on each file, in particular on each executable, class, and library, before the file is loaded. The measurements may be performed by calculating the hash value of the respective files. In addition, the computing system 1 includes an application loader 5 which, similar to the software-based integrity measurement component 4 on the system side, is configured to perform a measurement on each application file, before the file is launched/loaded. Again, the measurements may be performed by calculating the hash value of the respective files.

As illustrated in FIG. 1, the computing system 1 further includes an interface service 6, which is configured to receive the measurement results from software-based integrity measurement component 4 and from application loader 5. The service 6 directs the measurement results to the smart card 3, where specific applets execute a signing process in which the measurement results are signed together with a global counter of the smart card 3. Specifically, the applets are designed in such a way that they emulate the extend-only functionality provided initially by TPMs solely using lightweight cryptography and counters, as will be explained in more detail below.

When a verifier 7 wants to verify the integrity of the applications running on the computing system 1, he may send a challenge to the computing system 1. In order to check the measurement of each launched application to see if it has been tampered or not. The integrity of the measurement will be insured by the signature of the smart card 3, as will be explained in more detail in connection with FIG. 2.

FIG. 2 schematically illustrates the architecture of an Android operating system implemented in a mobile device that includes an integrated integrity measurement scheme in accordance with an embodiment of the present invention. In FIG. 2, same or like components are denoted with the same numerals as employed in connection with the embodiment of FIG. 1. Since the skilled artisans are familiar with the general concept of the Android operating system in mobile devices, the following description focuses on those aspects of the system that are relevant for embodiments of the present invention, while a detailed description of the general aspects of the architecture is omitted here.

In connection with the embodiment illustrated in FIG. 2, the following system and attacker model is considered: It is assumed that the entire software stack on the mobile device can be modified either by (i) an auditor (e.g., IT administrator that is interested in auditing the software status of the mobile device), and/or (ii) the attacker herself that can corrupt/modify the device's software (e.g., using malware, virus, etc.). It is assumed, however, that the device does not have any support for TPM chips and only has support for tamper-resistant hardware component 2 that offers secure storage of cryptographic keys, secure hosting of applets, secure cryptographic algorithms, etc. In the illustrated embodiment, the tamper-resistant hardware component 2 corresponds to a smart card 3, as typically employed in current mobile phones. It is assumed that a private key (PK) is stored on the smart card 3 in a way such that it can never leave the smart card 3.

Briefly, the illustrated embodiment for providing a secure and authenticated boot of the Android mobile device without relying on a TPM can be summarized as follows: The procedure starts with a integrity measurement software 4, e.g. IMA kernel module 8, which is modified so that each executable, class, library, etc. on the mobile device is measured before it is loaded. A service 6 is devised whose sole role is to interface between the kernel 9 and the smart card 3 located on the device. Preferably, the service 6 runs in kernel space, thereby being isolated from user-space applications, which strengthens its security against attacks. Specifically designed Java applets are constructed on the smart card 3 that emulate the extend-only functionality provided initially by TPMs solely using lightweight cryptography and counters.

Based on the above, single aspects of the embodiment will now be described in some more detail. As can be obtained from FIG. 2, the mobile device includes an application loader 5, e.g. a Java class loader, which has a hook inside that measures the hash of every application file before loading and launching the application file. As already mentioned above, the term ‘application file’ is to be understood in a broad sense. For instance, it can be provided that the application loader 5 also measures the class objects that are loaded in the memory if the measurement level is chosen to be Class Level instead of .apk Application Level. The measurement result will be sent to interface service 6, which is implemented as native daemon. For the sake of brevity, this native demand will be briefly denoted Imlogd (Integrity measurement logd) hereinafter. Upon receiving measurement results, Imlogd calls the smart card's 3 API (Application Programming Interface) and forwards the measurements to the smart card 3. Similarly, measurement results generated by the IMA kernel module 8 will also be sent to Imlogd and then directed to the smart card 3.

Mathematically, the above process may be implemented as described in the following steps 1-3:
1. After IMA kernel module 8 detects that Imlogd is loaded and running, it sends each new measurement (0, Mᵢ, H(mᵢ)) to Imlogd and waits for an acknowledgment (ACK or NAK) before continuing, where M, is the descriptor of the measured file (class, library), and H(mᵢ) is the hash of its content.
2. Whenever the DVM 10 (Dalvik Virtual Machine) or, more specifically, the respective application loader 5 tries to load an application (or class), it sends each new measurement (1, Mⱼ, H(mⱼ)) to Imlogd and waits for an acknowledgment (ACK or NAK) before continuing.
3. Upon the reception of each measurement (b, X, H(x)), Imlogd transforms it to an APDU (Application Protocol Data Unit) command and sends it through the SmartCard system to the smart card 3 service for signature, where b=0, X=M, (system level); b=1, X=Mⱼ (application level).

Upon reception of a signing request, the an applet on the smart card 3 applet will increase the corresponding global counter of the smart card 3, and sign the counter, the descriptor and the hashed value using its private key, and the signing result is returned to Imlogd for storage. At the same time, the smart card 3 also extends its register of the summary of the signatures, which in the described embodiment is done separately for system specific measurements IMA measurement list and for application specific measurements DVM measurement list. The register remains in the ROM of the smart card 3 and is extendable only.

Mathematically, the above process may be implemented as described in the following steps 4-6:

4. When the smart card 3 starts up, it first initializes the value of a global counter T and a local register ε₀ for each measurements list as 0. It also generates a local random value R_{S}.
5. After receiving a signing request, the smart card 3 increases its global counter T_{b}, and signs on value X_{T}^{b}=(T_{b}, X^{b},H(x^{b})). The result Y_{b}=(b, X_{T}^{b}, sig(R_{S},X_{T}^{b}) is sent back to Imlogd as response. Meanwhile, it extends its local register ε_{T}^{b}=H(ε_{T-1}^{b}, X_{T}^{b}), where b=0 for IMA and b=1 for DVM measurement list.
6. Imlogd keeps a measurement list of Y_{b} on the file system as a privileged file.

When a Verifier 7, e.g. an administrator, wants to verify the integrity of the running applications, he will send a challenge R to the mobile device, where R is an unpredictable random number. The mobile device (application) forwards the challenge to Imlogd, who again reforms the challenge to an APDU command and sends it to the smart card 3. The smart card 3 will then sign on the value of the registers along with the nonce R, and reply to the Imlogd the value of the registers as well as the signature. The Imlogd will in return, reply the Verifier 7 with the two measurement lists (of IMA and DVM, for system level and application level, respectively) along with the response from the smart card 3 to the Verifier 7. The Verifier 7 can thus check the hash of each launched application (or executable, library, kernel models, important configuration files, etc.) to see if it has been tampered or not. The integrity of the hash value, i.e. measurement, will be ensured by the signature of the smart card 3; and the integrity of the measurement list and its freshness will be ensured by the signed extended summary.

Mathematically, the above attestation steps may be implemented as described in the following step 7:
7. Attestation Step: The Verifier 7 sends nonce Rₙ to the mobile device, which is finally forwarded to the smart card 3 through Imlogd. The smart card 3, upon the reception of the verification challenge, prepares the final extended summary from its register value S=(R_{S}, ε⁰, ε¹, sig(Rₙ, R_{S}, ε⁰, ε¹)) and sends S back to Imlogd. Finally, Imlogd sends two measurement lists as well as the summary (\vec{Y}₀, \vec{Y}₁, S) back to the Verifier 7.

It is noted that according to the above embodiment randomness is introduced, thereby creating measurements that are unforgeable.

Before Smartcard System Service of smart card 3 is started, since until then only basic system components will be loaded, they can be launched according to a preset white list to ensure the integrity. The integrity of the DVM 10, for example, can be measured by IMA kernel module 8 as /system/lib/libdvm.so, and the integrity of Imlogd can be measured as /system/bin/imlogd. After Smartcard system service is launched, which means that now the smart card 3 is available for communication, each new measurement will be sent to the smart card 3, which includes the messages originated from IMA kernel module 8. The signed measurements are then sent back to Imlogd which stores in its list \vec{Y}_{b}. Upon the attestation request, the measurement lists and the extended summary are subsequently sent to the Verifier 7.

Since all the applications (or executable, libraries, etc.) will be measured before launching, it is assumed that the attack from an adversary is to rewrite the measurement result of its tampered applications. By the architecture and protocol according to the above embodiment, such attack is prevented since it is always detectable by the Verifier 7. The reasoning is stated as following:

First of all, an adversary cannot change certain measurement entries, as each measurement was signed by the smart card 3, neither can she trick the smart card 3 to get a replaceable signature of a genuine measurement to replace the existing one, as the increase-only global counter T_{b} is maintained by the smart card 3 and is included in the signatures. It is also not possible for the adversary to replace a measurement entry with a correct one from an existing history, since at the beginning of each execution, the smartcard always refresh a random value which is included in all the signatures. Another insurance layer is provided by the extended summary inside the smart card 3, so that any manipulation of the measurement list will be detected.

Upon an attestation request, if the adversary wants to fool the Verifier 7 by sending an old genuine proof (i.e. measurement lists and summary) from a history running, such an attack cannot be successful since the extended summary comes along with a signature on the a fresh nonce from the Verifier 7.

Since all the measurements will be cleared on a reboot of the system, the adversary may want to reboot the mobile device and give a clean measurement result upon an attestation request. However, on the side of the Verifier 7, one can set a response time window to detect such case, as the reboot time will bring a big difference in the delay of the response.

According to another embodiment, which constitutes an even stronger mechanism than the mechanism as described so far, derived keys for each DVM measurement entry are used, so that the message (1, Mⱼ, H(mⱼ)) will be encrypted in the channel between DVM 10 and Imlogd in a way that preserves the secrecy of all keys used prior to any attack by an adversary. According to this embodiment, the key is derived and updated as follows:
1) After Zygote 11, which in Android loads the core Java classes and performs initial processing of them, is started, each time when it forks itself for a new DVM 10, it will assign a random ID for the DVM 10 and communicate with the smart card 3 (through Imlogd) to get a derived key K0 from a master key that only resides on the smart card 3. In this way, each new DVM 10 will have a pair (ID, K₀) when it is first started.
2) Upon each new measurement(1, Mⱼ, H(mⱼ)), the DVM 10 will keep a local counter t and encrypt its value as C_{id,t}=Enc_{K}_{_{id,t}}^{aes}(ID, t, X, H(x)), and send message (1, ID, t, C_{id},ₜ) to the smart card 3 (through Imlogd).
3) Meanwhile, the DVM 10 updates the derived key to K_{id,t+1}=H(K_{id,t}) and deletes key K_{id,t}.
4) The smart card 3 derives K_{id,t} according to the value (ID, t) and its master key, so that it is able to decrypt the message and get the measurement entry. Then the smart card 3 signs on the measurement with the subsequent steps being identical to steps 4-6 as described above.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for performing a secure boot of a mobile device computing system that includes a tamper-resistant hardware that provides secure storage of at least a cryptographic private key, the method comprising:
performing a measurement on each of one or more system specific and/or application specific files before each file is loaded or launched by a kernel module or an application loader of the computing system to produce measurement results;
directing the measurement results to the tamper-resistant hardware;
maintaining an extend-only global counter at the tamper-resistant hardware;
increasing the extend-only global counter upon receiving one of the measurement results;
executing a signing process in which the tamper-resistant hardware signs the extend-only global counter together with the measurement result using the cryptographic private key; and
keeping a measurement list at the computing system that includes signatures generated by the tamper-resistant hardware.

2. The method according to claim 1, wherein the tamper-resistant hardware maintains an extend-only local register of a summary of the signatures generated by the tamper-resistant hardware.

3. The method according to claim 2, wherein the extend-only local register is extended each time the tamper-resistant hardware executes the signing process.

4. The method according to claim 1, wherein the one or more system specific and/or application specific files include one or more of classes, libraries, executables, kernel models, application files or configuration files.

5. The method according to claim 1, wherein the performing a measurement on each of one or more system specific and/or application specific files comprises calculating a hash of the content of the file being measured.

6. The method according to claim 1, wherein a service is provided on the computing system that interfaces between a kernel of the computing system and the tamper-resistant hardware.

7. The method according to claim 6, wherein the service is configured to receive the measurement results and to direct the measurement results together with respective signing requests to the tamper-resistant hardware.

8. The method according to claim 6, wherein the service is configured to receive the signatures generated by said tamper-resistant hardware and to keep the measurement list.

9. The method according to claim 1, wherein the performing a measurement on each of one or more system specific and/or application specific files comprises performing a measurement on a system specific file by a software based integrity measurement component implemented on the computing system.

10. The method according to claim 1, wherein the performing a measurement on each of one or more system specific and/or application specific files comprises performing a measurement on an application specific file by an application loader implemented on the computing system.

11. The method according to claim 1, wherein a measurement list is generated and stored separately for measurements performed on system specific files and a measurement list is generated and stored separately for measurements performed on application specific files.

12. The method according to claim 1, wherein measurement results related to application specific files are encrypted before being directed to a service provided on the computing system by using a key derived from a master key of the tamper-resistant hardware.

13. The method according to claim 1, wherein basic system files of computing systems that are loaded before the tamper-resistant hardware becomes active are launched according to a preset white list.

14. A mobile device computing system with secure boot functionality, the mobile device computing system comprising:
tamper-resistant hardware that provides secure storage of at least a cryptographic private key;
a memory for keeping a measurement list that includes signatures generated by the tamper-resistant hardware; and
at least one of:
a software based integrity measurement component configured to perform a measurement on each of at least one system specific file, or
an application loader configured to perform a measurement on each of at least one application specific file before each is loaded or launched, and to direct the measurement results to the tamper-resistant hardware,
wherein the tamper-resistant hardware is configured to maintain an extend-only global counter, to increase the extend-only global counter upon receiving a measurement result, and to execute a signing process in which the extend-only global counter together with the measurement result is signed using the private key to generate the signatures.

15. The computing system according to claim 14, wherein the tamper-resistant hardware is a SIM card.

16. The computing system according to claim 14, wherein the software based integrity measurement component is provided in the computing system and includes an IMA kernel module.

17. The computing system according to claim 14, wherein a service is provided that interfaces between a kernel of the computing system and the tamper-resistant hardware component.

18. The computing system according to claim 17, wherein the service is implemented as a native daemon.

19. The computing system according to claim 17, wherein the service is implemented to run in kernel space.

20. A method for performing remote attestation of a mobile device computing system that includes a tamper resistant hardware that provides secure storage of at least a cryptographic private key, the method comprising:
performing a secure hoot of a mobile device computing system that includes a tamper-resistant hardware that provides secure storage of at least a cryptographic private key by:
performing a measurement on each of one or more system specific and/or application specific files before each file is loaded or launched by a kernel module or an application loader of the computing system to produce measurement results;
directing the measurement results to the tamper-resistant hardware;
maintaining an extend-only global counter at the tamper-resistant hardware;
increasing the extend-only global upon receiving one of the measurement results;
executing a signing process in which the tamper-resistant hardware signs the extend-only global counter together with the measurement result using the cryptographic private key, and
keeping a measurement list at the computing system that includes signatures generated by the tamper-resistant hardware;
sending, by a verifier, an attestation request including a challenge to the computing system, wherein the challenge is directed to the tamper-resistant hardware;
upon receiving the challenge, preparing, by the tamper-resistant hardware, an extended summary of the measurement results from a register of the tamper-resistant hardware; and
sending to the verifier the extended summary of the measurement results with the measurement list such that the integrity of each loaded file can be verified by checking signed ones of the measurement results.

21. The method according to claim 20, wherein the challenge includes a random number.

22. The method according to claim 20, wherein the verifier specifies a time window for receiving a response to an attestation request from the computing system.
